(19) United States
(12) Patent Application Publication
(10) Pub. No.: US 2006/0069470 A1
(43) Pub. Date: Mar. 30, 2006

(54) BI-DIRECTIONAL ABSOLUTE AUTOMATED TRACKING SYSTEM FOR MATERIAL HANDLING

(75) Inventors: Philip L. Campbell, Millbrook, NY (US); Jeffrey P. Gifford, Fishkill, NY (US); Uldis A. Ziemins, Poughkeepsie, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/711,696

(22) Filed: Sep. 30, 2004

(51) Int. Cl. G06F 19/00

(52) U.S. Cl. 701/23; 180/167

(57) ABSTRACT

Communication between a controller and a set of automated vehicles in a manufacturing facility is improved by use of a closed-loop control system that operates on a real-time interrupt basis in which autonomous carriers report their location, sensed from reference markers along a track, the reference markers being referenced to an absolute grid in space, to a central controller or to one of a set of zone controllers that monitor the location of nearby vehicles that ordinarily use a token-passing system to avoid collisions, but which controllers can intervene to prevent one vehicle from blocking or interfering with another.

### TECHNICAL FIELD

The field of the invention is that of transporting materials within a building or other location with set of autonomous automated vehicles; in particular transporting a load along a track in a remotely controlled vehicle.

### BACKGROUND OF THE INVENTION

In the field of material transport through automated vehicles, it is necessary for a controller to communicate with individual ones of the vehicles to tell it to start, follow a certain path to a destination and to unload.

Conventional present-day systems use open-loop technology, in which the vehicle is told to start moving and then continues until it reaches its destination or suffers a malfunction.

Communication between the controller and the individual vehicles is plagued by noise and other interference.

In a common approach to vehicle control, the vehicle is not left alone to proceed to a destination, but is periodically told to continue moving, with the fail-safe response to stop (for safety reasons). If contact is lost with the controller, the vehicle will be stranded between a start location and an end location.

Control signals are conventionally broadcast throughout a relatively large factory space, with potential for causing interference with other equipment that responds to a signal meant for the material handling system.

Since the controller doesn't know where individual vehicles are, collision avoidance requires a conservative margin of safety such as permitting only one vehicle at a time to operate within a relatively large area.

The art could benefit from a closed-loop system in which a controller is aware of the location of the individual vehicles and can prevent collisions while decreasing the time required to move from a start location to a destination.

The art would also benefit if, when a new route or new tooling is required to be installed in the system, re-teaching the system is not required or if layout data could be changed insitu allowing continuous operation of the system.

The art would also benefit if all points in the space were specified in a coordinate system and if the complete track were encoded and each destination unique and mapped.

### SUMMARY OF THE INVENTION

The invention relates to a system for controlling automated material handling units in a high-noise environment.

A feature of the invention is a closed loop system in which the individual units communicate with a central controller.

Yet another feature of the invention is a real-time interrupt driven communication scheme.

Yet another feature of the invention is avoidance of collisions between carriers through token-passing in congested locations and/or intersections.

Yet another feature of the invention is that the system can use one master controller or several zone controllers, together with a set of readers and semaphores that is scalable and can be readily configured depending on size and complexity of the factory.

### BRIEF DESCRIPTION OF THE DRAWINGS

FIG. 1 illustrates in block diagram form a master controller and unit controller.

FIG. 2 illustrates a detail of the leaky coaxial antenna which encompasses the entire perimeter of the bay.

FIG. 3 illustrates a top view of a typical installation.

### DETAILED DESCRIPTION

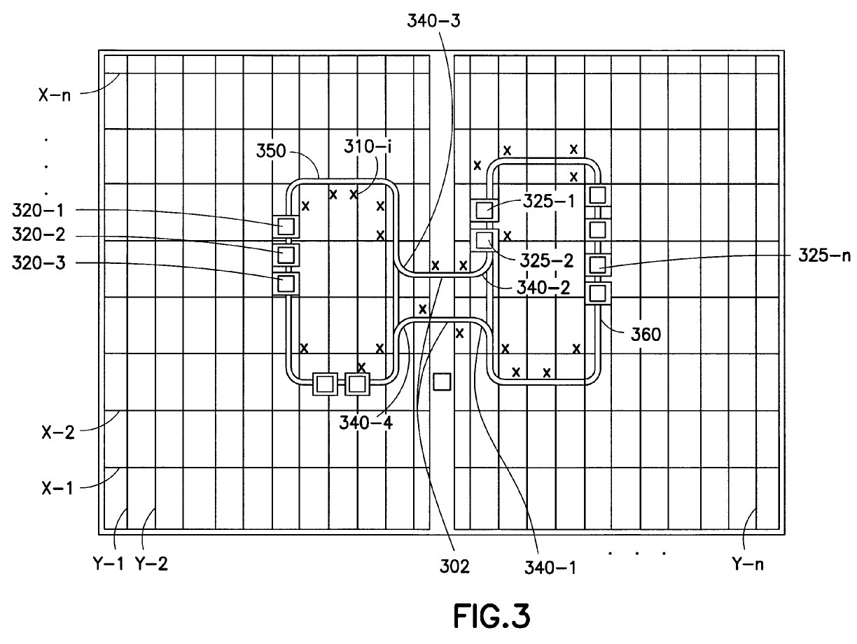

FIG. 3 illustrates a simplified overhead view of factory installation of the invention. A grid Y-1, Y-2, - - - Y-n and X-1, X-2, - - - X-m divides the Y-direction and X-directions. A pair of loop tracks 350 on the left and 360 on the right support material carriers that stop at a set of processing locations 320-1, 320-2, etc on the left loop and 325-1, 325-2, 325-n on the right loop. Between the loops switch points 340-1 to 340-4 permit individual carriers to leave one loop and travel to another one.

In a typical installation of the invention, there may be many loops, which will sometimes be referred to as bays in typical terminology. The example illustrated is taken from a semiconductor wafer processing facility, or fab, but the invention may be practiced in many locations and types of facilities.

The system provides intelligence in both the overhead rail/controller system and in the OHT vehicle to provide a true closed loop tracking and monitoring system. The smart track is equipped with an encoder, either barcode (two or one dimensional), magnetic or optical encoding system. The complete factory has a grid system overlay where each location in the factory has a unique encoder value.

Another advantageous feature of the system is the simplicity of adding new tools or load ports in the system. Because each location has a unique encoder position association, the master controller can easily be updated to reflect a new load port at any encoder position in the factory. With the availability of the grid, referenced to an absolute coordinate system fixed in space, the need for any new encoder tape installation or new map data sent to vehicles or rail is eliminated. The system is aware of all unique locations in the factory upon installation. The master controller can update all vehicles that a new load station has been installed and command delivery to the new location when required. Thus, the tedious teaching methods and configuration of the system required in the prior art to commission new stopping locations and the associated down time from production while the setup and configuration to introduce data in the carrier takes place is eliminated.

In a first approach to vehicle location, the OHT vehicle can ascertain and verify its location anywhere in the factory stand alone by reading the markings on the rail or by reporting data to a master or zone controller and receiving a location after the controller has processed the data. The overhead rail would also have bar code readers, magnetic tape reader or optical readers to allow identification of vehicles as they travel within the factory. Alternatively, the global positioning system (GPS) could be another means of tracking vehicles within the factory and providing real time feedback to the master controller. Utilizing GPS could eliminate or limit encoding the overhead rail directly due to the system's own ability to provide absolute encoded information via triangulation techniques. Encoding the track could be used in combination with the GPS to provide the accuracy required during final delivery or as redundant tracking if necessary. Transponders could be attached to each OHT vehicle with a unique frequency or system address to allow tracking within the factory. A radar type screen and or computer interface could be utilized to resolve all OHT vehicles in the factory real time and provide vehicle routings

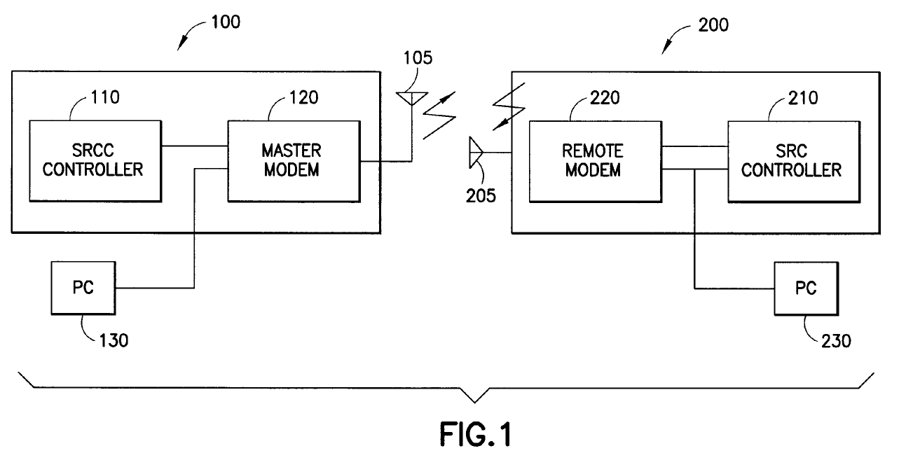

For simplicity, two loops are shown in FIG. 1, but those skilled in the art will appreciate that many loops can be connected along a main track, with carriers branching to and from the main track to reach destinations in other bays. Advantageously, the carriers are capable of bi-directional operation, e.g. having an electric motor with leads that can be reversed to reverse the direction of travel. This permits a carrier to enter a siding on the track, then back out, or back away from a congested area to take a detour and otherwise to operate more flexibly.

The X symbols denoted 310-i represent the locations of markers along track 350 and 360. These markers may be part of an encoder system such as that supplied by NorthStar Technologies of Waterville Ohio or a number of other commercial suppliers. The particular example cited is capable of 10 micron resolution. Designers will select a system suitable for their needs based on the usual cost/accuracy tradeoffs.

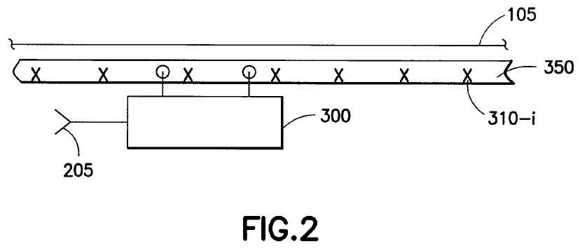

FIG. 2 shows a simplified side view of a portion of a track. A carrier indicated schematically by box 300 travels along a track 350. Markers 310-i are positioned along the track, so that the carrier receives as input sequential indications (e.g. magnetic pulses) that represent passage past a marker. The markers may be coded with identifying numbers or the system may keep count of the markers passed since the start of a particular trip.

Each vehicle can be sent via the master or zone controller to destinations utilizing specific routings to avoid traffic congestions with wireless communication (such as that shown in copending application Ser. No. 10/709,351, “Automation System Using Wireless High Frequency” assigned to the assignee hereof and incorporated herein by reference), Ethernet, or any other convenient means of communication. The system is preferably interrupt driven to verify vehicle location and final destination. Present systems are polling type systems which rely on constant polling or inquisition of vehicle to vehicle or vehicle to master controller location. This system is event driven where the overhead track and vehicle communicate in an orderly event driven fashion at each reader on the track or GPS location to ascertain and verify present location. The system could be vehicle specific or vehicle generic depending on final system configuration requirements.

At the top of FIG. 2, line 105 represents an antenna, illustratively a twin-lead, that carries a signal from the central controller of the system. Antenna 205, attached to box 300, receives signals from antenna 105 and transmits return signals, so that the system has the capability of closed loop operation, in which the controller knows the location of individual carriers and individual carriers respond to commands from the controller.

Closed-loop operation is desirable even when the vehicles are autonomous, since one or more vehicles may make an error. The controller can then intervene to avoid a collision or other problem.

As a simplified illustration, suppose the nth carrier is to travel from location 320-2 on track 350 to location 325-3 on loop 360, carrying a load of integrated circuit wafers from one processing station to another.

The carrier will travel to the first input location, pick up its load using standard robotic material handling techniques known in the art and travel to the destination where it unloads the cargo.

On the way, the carrier will pass by other processing locations and pass through two switches 340. At each switch or at each processing location, it may encounter another carrier. It may also suffer a malfunction and stop or slow significantly.

In operation, the nth carrier senses the encoding references on the track (or on an associated magnetic strip, optical bar code, etc.). The most recent marker is stored within the carrier and updated as the carrier passes additional markers. The computer within the carrier compares the sensed location with a predicted location based on the standard speed of the carrier and the measured distance between the references. This comparison may be performed at intervals selected by the system designer, at every reference, every second reference, every kth reference, etc. The carrier has stored within it an observed location and a predicted location.

At intervals, e.g. locations 310-i, sensing equipment (optical, magnetic or any other method) on or with the track senses the presences of a carrier. The track then interrogates the carrier by sending a signal over the antenna and receives from the carrier a response with the carrier address and the stored and/or predicted location of the carrier. The local controller compares the predicted location of the carrier that is received from the carrier with the measured location of the checkpoint. If a difference exceeds a controller deviation threshold, the local controller can send a location correction message to the carrier that causes it to correct its stored location. Optionally, the local controller can send an error message to a master controller.

Similarly, the carrier has stored a prediction as to when it will pass the checkpoint, based on its speed and the stored location of a previous position along the track. If the time of passing the checkpoint deviates from the predicted time by an amount greater than a carrier deviation threshold, the carrier initiates an error correction process, updates its stored values and optionally notifies the controller.

Thus, there are two closed-loop systems—one in the carrier that monitors the performance of that carrier and another in the controller that monitors all the carriers within the zone of responsibility of that controller.

Avoidance of collisions is required in material handling systems using multiple carriers and the methods in the past have been quite conservative, with carriers being prohibited from entering a relatively large region that contains another carrier.

Another method of avoiding collisions is to have the system provide access to intersections and congested areas implementing a token pass system. A vehicle approaches an area that often has more than one vehicle that wants to operate in it (such as an intersection between a bay and a main section of track). A first vehicle receives a token from a local controller. Once the vehicle receives the token it is allowed to travel freely within the area and then, when leaving the area, the vehicle returns or passes the token allowing access to other vehicles. The token could be implemented by any communication or semaphore signaling in numerous options via, optical, mechanical, Ethernet, GPS or modem. The method is to allocate clearance via acceptance of the token and then passing the token to other vehicles that want to enter the area. This method again utilizes an interrupt versus polling scenario of access.

Since the master controller knows where each carrier is located, it can shunt aside one carrier to let another pass (or hold up one carrier while another carrier passes on an intersecting track, etc.). This permits the system to use carriers more efficiently, because less time will be wasted while a carrier waits for a free track.

The system achieves high speed throughput at 115.2 Kbps by employing forward error correction and multiple resends. A master control station utilizes FHSS (frequency hopping spread spectrum) for reliable secure data transmission. Each vehicle sends data back to the master controller and the master controller broadcasts to all vehicles via an encrypted header for segregating bays and zones in the same proximity. A frequency range of 902 to 928 MHz is utilized and shared with a wireless phone system. Any frequency band that does not require FCC licensing and utilizes spread spectrum technology could be implemented.

Optionally, in the course of operation, vehicle A broadcasts its location and direction to all vehicles within the limited reception range. These other vehicles compare the path of vehicle A and compute whether they will collide. A predicted collision will result in either a signal to the controller to work out a solution, or an autonomous solution, depending on the system structure.

FIG. 1 illustrates simplified block diagrams of the master controller and of a typical carrier.

On the left, controller 100 contains a block 110 that contains the software that drives the system, illustratively a general purpose computer, and a modem 120 that is illustratively a high frequency spread spectrum modem. At the bottom of the Figure, PC 130 is available, either continuously or at intervals, to supply greater computing power to run diagnostic tests to set up the system or diagnose faults, both of which typically require a more sophisticated system and much more complex software than the operation software.

On the right of the Figure, carrier 200 contains the same modem 220 connected to an omni-directional antenna 205 on the vehicle. Controller 210 contains the robotic control software to load, unload the cargo, operate the vehicle, etc.

The carrier will typically be waiting for commands from the system controller for most of the time. When it receives a command, e.g. go to location 320-3 and pick up a load, the controller 210 branches to the correct location in its memory and executes the detailed instructions to carry out the high-level command.

In a particular example, the modem is a commercially available MDS TransNet FHSS (Frequency Hopping Spread Spectrum) modem, available from MDS Inc., operating in the ISM band of 902 to 928 MHz. Other modems could be used in the high frequency range of 1-5 MHz. An advantage of the present invention is that the same band can be shared with a telephone system without interference.

The capacity of systems according to the invention is quite large; e.g. 28 separate controller sub-systems for controlling handling in different portions of the facility. Each sub-system has a different address, which facilitates separation of commands.

For example, the controller in the 12^{th} bay will send commands to the carriers operating in that bay. The carriers in the 11^{th} and 13^{th} bays will be in range of the transmissions in the 12^{th} bay (and vice versa). The 12^{th} controller will send out its commands with an address header on the command that is recognized by its carriers and ignored by other carriers.

When a carrier travels from the 12^{th} bay to the 13^{th} bay, it is recognized by the local controller and thereafter controlled by it. A straightforward way to implement the handoff is for the local controller to send a signal to the master controller that, in turn, instructs the local controller in the next bay that the carrier is coming, the address of the carrier and other information as required by that particular system to permit the new local controller to take over control of the carrier while it is in that territory.

Crosstalk between vehicles in a bay and/or between adjacent bays is avoided by use of the spread spectrum modems and also by a header on the messages that identifies the bay and the vehicle within the bay. A unique header protocol is required to isolate one or more vehicles that constitute a group or single vehicle depending on the application. The header utilizes a checksum or parity control to indicate which vehicle and bay the message is directed to and is to be processed by.

Signal to noise ratio (SNR) has been optimized in the system. By amplifying the transmitter's power and then using various attenuators, located in the coax to distribute power in various portions of the bays, the SNR was optimized to improve communication between modems and separation of vehicles and bays.

Antenna design and implementation were found have a significant effect on reliable communication. The location and combination of both omni-directional and leaky coax antennas were also significant. There is an omni-directional antenna on the side of each vehicle which is approximately 6 inches from the leaky coaxial cable located around the perimeter of each bay. Various bays were equipped with omni antennas located at strategic locations (determined empirically) in the bay to improve communication, so that there were two RF links in such bays—the link through the extended conductor and a direct link over the air interface between the two omni antennas.

The system designer may choose to have the modems respond to a fixed address or, alternatively, respond to a channel. For example, in mobile phone systems, the nth user has a spreading code and responds to any signals that are picked up by the spreading code—i.e. on that channel. On a computer bus, each peripheral has an address and ignores data that it could respond to if the address is wrong.

While the invention has been described in terms of a single preferred embodiment, those skilled in the art will recognize that the invention can be practiced in various versions within the spirit and scope of the following claims.

What is claimed is:

1. A system for controlling a set of material carriers in real time under control of a master controller comprising:
a set of at least two material carriers containing a data processing unit;
at least one master controller adapted to command said carriers to transport loads;
a set of path marking references disposed along at least one path traversed by said material carriers; in which
at least one of said master controller and said carriers contains a data processing unit for operating a real time closed loop interrupt driven position monitoring system that senses the passage of a carrier at a location.

2. A system according to claim 1, in which a carrier senses the locations of path marking references that it passes and transmits to a controller data pertaining to its passage past such path marking references.

3. A system according to claim 2, in which said path marking references are related to a coordinate system fixed in space.

4. A system according to claim 1, in which said carrier senses its location in one of: a) reading markers that are part of an absolute encoder fixed in space; b) responding to signals from at least one GPS system; and c) receiving transmissions from a local source that has sensed the passage of said carrier.

5. A system according to claim 1, in which said extended conductor comprises one of: a) a coaxial cable having RF leakage along its length sufficient to transmit to said antenna; and b) a twin-lead conductor.

6. A system according to claim 1, in which each carrier receives a location signal from nearby carriers indicating the position of said nearby carriers and broadcasts location information indicating its own location and in which at least one carrier processes said location signal from nearby carriers indicating the position of said nearby carriers to calculate therefrom whether said at least one carrier will collide with one of said nearby carriers.

7. A system according to claim 6, in which said controller receives said location signal from said nearby carriers indicating the position thereof and calculates therefrom whether any of said nearby carriers will collide with another one of said nearby carriers.

8. A system according to claim 1, in which said master controller communicates with a set of zone controllers, each of which controls a set of carriers within a corresponding zone of said system, through one of: a) separate addresses for each zone and b) through separate channels in an RF spread spectrum transceiver.

9. A system according to claim 1, in which at least one controlled location on said path is controlled by a token-passing system in which a carrier having a token is able to travel through said congested location and carriers not having said token are prevented from entering said controlled location.

10. A system according to claim 9, in which said token is implemented through semaphore signaling.

11. A system according to claim 1, in which the locations of said path marking references are referenced to an absolute coordinate system, whereby said carriers are adapted to travel to a new location in said coordinate system upon command without a setup procedure to enter data in said carriers.

12. A system according to claim 1, in which said carriers contain means for traveling in both a first direction along said path and along a second direction opposite said first direction, thereby permitting bi-directional travel.

13. A system according to claim 8, in which said zone further comprises at least one antenna connected to a zone controller, whereby said zone has an air interface link in addition to said link comprising an extended conductor.

14. A system according to claim 13, in which each carrier receives a location signal from nearby carriers indicating the position of said nearby carriers and broadcasts location information indicating its own location.

15. A system according to claim 14, in which at least one carrier processes said location signal from nearby carriers indicating the position of said nearby carriers to calculate therefrom whether said at least one carrier will collide with one of said nearby carriers.

16. A system according to claim 14, in which said zone controller receives said location signal from said nearby carriers indicating the position thereof and calculates therefrom whether any of said nearby carriers will collide with another one of said nearby carriers.

17. A system according to claim 8, in which an extended conductor in at least one zone comprises at least one attenuator adapted to reduce signal power transmitted from said extended conductor in an area of said at least one zone.

18. A method of exchanging data between a set of material carriers under control of a master controller and said master controller comprising:
providing a set of at least two material carriers having a spread spectrum RF transceiver;
providing said master controller unit having a spread spectrum RF transceiver;
communicating between said controller and said set of carriers passes through a link comprising an extended conductor connected to said controller and an antenna connected to each carrier; and
processing, in each carrier, data received by said RF transceiver.

19. A method according to claim 18, in which each carrier receives a location signal from nearby carriers indicating the position of said nearby carriers and broadcasts location information indicating its own location.

20. A method according to claim 19, in which at least one carrier processes said location signal from nearby carriers indicating the position of said nearby carriers to calculate therefrom whether said at least one carrier will collide with one of said nearby carriers.
